(19) United States
(12) Patent Application Publication
(10) Pub. No.: US 2016/0143289 A1
(43) Pub. Date: May 26, 2016

(54) Coating for Rice Seed to Aid in Stand Establishment

(71) Applicant: Clarence Calvin Bowling, Salem, AR (US)

(72) Inventor: Clarence Calvin Bowling, Salem, AR (US)

(73) Assignee: Clarence Calvin Bowling, Salem, AR (US)

(21) Appl. No.: 13/999,477

(22) Filed: Mar. 4, 2014

(51) Int. Cl. A01N 59/06

(52) U.S. Cl. CPC A01N 59/06

(57) ABSTRACT

A procedure for coating rice seed with rapid water absorbing treatment that provides the grower with options for dry or started seeds broad cast into flooded fields or drill planting started seeds in dry fields for stand establishment.

### BACKGROUND OF THE INVENTION

All presently used methods of stand establishment in mechanized rice production require the use of large amounts of water. Rainfall, flushing or flooding from reservoirs or live streams followed by draining and drying to provide adequate oxygen. This procedure provides ideal conditions for germination seeds of weeds and grasses. Some species of rice field mosquitoes also require damp soil for egg deposition. Valuable plant food is also lost by flooding and draining for stand development.

This invention relates to formation of a combination of several active and non-active materials which can be applied as a coating to seed rice to aide in stand development. Treated seeds may be planted immediately after treatment or held in storage.

SET: Stand Establishment Treatment is composed of any number of biological or synthetic water absorbing fibers plus calcium peroxide.

SET is made as a dry product which is mixed with a small amount of H²O for application to seeds, to be stored.

SET is mixed with large amounts of water for seed to be treated and held for several days before planting.

SET was developed primarily for rice fields, but may be useful on other field crops when soil moisture is too high or when soil moisture is too low.

1. I claim a coating for rice seeds that will enhance germination and growth of seedling without flushing or flooding the entire field.

2. I claim the use of a coating for rice seeds that are to be planted for stand establishment, in flooded or dry fields.

3. I claim a coating for rice seeds that can serve as a carrier for other useful materials such as fungicides, insecticides, growth regulators, plant nutrients and micro nutrients which may sometimes be needed for seedling health.
